(19) United States
(12) Patent Application Publication
(10) Pub. No.: US 2023/0122077 A1
(43) Pub. Date: Apr. 20, 2023

(54) POUCH CELL AND ELECTRICITY STORAGE BATTERY

(71) Applicant: Faurecia Systemes D'Echappement, Nanterre (FR)

(72) Inventor: Frédéric Greber, Ecot (FR)

(21) Appl. No.: 17/966,213

(22) Filed: Oct. 14, 2022

(30) Foreign Application Priority Data
Oct. 15, 2021 (FR) 2110979

(51) Int. Cl. H01M 50/105; H01M 50/178; H01M 50/543; H01M 50/211; H01M 10/613; H01M 10/625; H01M 10/6556; H01M 10/6568; H01M 50/293

(52) U.S. Cl. CPC H01M 50/105; H01M 50/178; H01M 50/543; H01M 50/211; H01M 10/613; H01M 10/625; H01M 10/6556; H01M 10/6568; H01M 50/293; H01M 2220/20

(57) ABSTRACT

A pouch cell according to the present disclosure can comprise a sealed pouch; a positive terminal emerging from the pouch through a longitudinal large upper edge; and a negative terminal emerging from the pouch through the large upper edge. The large upper edge of the side can have a longitudinal edge length. The positive terminal and the negative terminal together can have a longitudinal terminal length of more than 70%, preferably 80% or more, of the edge length.

### PRIORITY CLAIM

This application claims priority to French Patent Application No. FR 21 10979, filed Oct. 15, 2021, which is hereby incorporated in its entirety herein.

### FIELD OF THE DISCLOSURE

The present disclosure relates in general to electric batteries equipped with pouch-type electricity storage cells.

### BACKGROUND

The application filed in France under number FR2108152 describes a first technical solution for organising the cooling of pouch cells in an electricity storage battery. Several cells are overmoulded in resin to form a coherent module. Ducts are provided inside the module to allow the cooling of the pouch cells with a dielectric fluid. This liquid flows in direct contact with the terminals of the pouch cells. It also cools the small sides of the pouch cells, as well as the large sides through the resin. Finally, thermally conductive plates are placed against the large faces of the pouch cells, so as to conduct the heat from these large faces to the ducts in which the dielectric liquid circulates.

A second technical solution, illustrated in FIG. 7, consists of pressing the pouch cells CP against each other, with plates P of a material such as aluminium being interposed between the large faces of the neighbouring cells. The aluminium plates conduct the heat generated by the cells to a base plate PB, in contact with which a heat transfer fluid FC circulates.

The first technical solution can be cumbersome and can have the drawback of using a large number of parts. In addition, the assembly of the modules can be relatively complex. The second technical solution can have some or all the same shortcomings.

In this context, the present disclosure aims to provide in a first aspect a newly designed pouch cell, which can be more easily integrated into a dielectric-fluid-cooled electricity storage battery, and which offers excellent cooling performance.

### SUMMARY

The present disclosure relates in a first aspect to an electricity storage pouch cell, comprising:
a sealed pouch of a flexible material, having two large faces opposite each other and a side connecting the two large faces to each other, the side comprising a longitudinal large upper edge and a longitudinal large lower edge opposite each other, the side further comprising two small edges opposite each other and connecting the large upper edge and the large lower edge to each other;
a cathode and an anode, arranged inside the pouch;
a positive terminal emerging from the pouch through the large upper edge, the positive terminal having an inner positive part located inside the pouch and electrically connected to the cathode, and an outer positive part located outside the pouch;
a negative terminal emerging from the pouch through the large upper edge, the negative terminal having an inner negative part located inside the pouch and electrically connected to the anode, and an outer negative part located outside the pouch;
the large upper edge of the side having a longitudinal edge length;
the positive terminal and the negative terminal together have a longitudinal terminal length of more than 70%, preferably 80% or more, of the edge length.

This means that the positive and negative terminals are together on the same side of the pouch, making it easier to integrate the pouch cell into a battery. The large lower edge can be placed against the bearing surface of the battery casing, with all terminals facing the cover.

Placing the two terminals together on one side also allows the terminals to be conveniently used for cooling the pouch cells, by easily circulating the dielectric fluid in contact with the two terminals. In FR2108152, the two terminals are located one on each short side of the pouch, so that two circulation channels are required at both ends of the cell for cooling the two terminals.

In addition, providing the longest possible terminals in the longitudinal direction improves heat transfer between the interior of the cell and the dielectric fluid used to cool the pouch cell, and more specifically between the interior of the pouch cell and the terminals.

The pouch cell may furthermore exhibit one or more of the following features, taken in isolation or in any combination that is technically possible:
the positive and negative terminals are plates extending in a single plane containing the longitudinal direction and an elevation direction, substantially perpendicular to the longitudinal direction;
the pouch has a pouch height in the elevation direction;
the outer negative part has, along the elevation direction, a negative terminal height such that the pouch height is between 2 and 5 times the height of the outer negative part of the negative terminal, and/or the outer positive part has, along the elevation direction, a positive terminal height such that the pouch height is between 2 and 5 times the height of the outer positive part of the positive terminal;
the positive and negative terminals together have, in said plane, a terminal area, the pouch having, in said plane, a cross-section with a pouch area between 7 and 11 times the terminal area.

According to a second aspect, the present disclosure relates to an electricity storage battery, comprising:
a plurality of electricity storage pouch cells, each pouch cell comprising:
   a sealed pouch of a flexible material, having two large faces opposite each other and a side connecting the two large faces to each other, the side comprising a longitudinal large upper edge and a longitudinal large lower edge opposite each other, the side further comprising two small edges opposite each other and connecting the large upper edge and the large lower edge to each other;
   a cathode and an anode, arranged inside the pouch;
   a positive terminal emerging from the pouch through the large upper edge, the positive terminal having an inner positive part located inside the pouch and electrically connected to the cathode, and an outer positive part located outside the pouch;
   a negative terminal emerging from the pouch through the large upper edge, the negative terminal having an inner negative part located inside the pouch and electrically connected to the anode, and an outer negative part located outside the pouch;
an outer casing, internally delimiting a receiving volume for the pouch cells, the pouch cells being arranged so that the large upper edges face in the same upper direction;
a circuit for cooling the pouch cells containing a dielectric fluid, the cooling circuit being configured so that the dielectric fluid flows in direct contact with the positive and negative terminals of the pouch cells.

Thus, in this electricity storage battery, all the terminals point in the same direction. It is therefore easy to install a cooling circuit in direct contact with the terminals, and this contact allows the pouch cells to be cooled efficiently at a lower cost.

The design of the electricity storage battery is considerably simplified compared to the situation described in prior designs.

The electricity storage battery may furthermore exhibit one or more of the following features, taken in isolation or in any combination that is technically possible:
the pouch cells are cooled only by circulation of the dielectric fluid in direct contact with the positive and negative terminals of the pouch cells;
the pouch cells have the characteristics defined above;
the large upper edges of the pouch cells define an upper surface, the battery comprising a plate having a lower surface facing the upper surface, the lower surface having a plurality of dielectric fluid flow channels formed therein, the positive and negative terminals of the pouch cells being engaged in the channels;
the channels are straight and extend over substantially the entire width of the battery, the pouch cells being arranged so that the positive and negative terminals lie in a plurality of straight lines parallel to each other, the positive and negative terminals lying in the same straight line being engaged in the same channel;
the battery comprises beams rigidly fixed to the casing and, delimiting in the receiving volume, a plurality of housings, the pouch cells being distributed in several modules, each module being inserted in one of the housings and rigidly fixed to the beams by a layer of elastic resin;
a plurality of modules are inserted in a single housing, said modules being separated by a layer of said elastic resin.

### BRIEF DESCRIPTIONS OF THE DRAWINGS

Further features and advantages of designs informed by the present disclosure will be apparent from the detailed description given below, by way of indication and not in any way limiting, with reference to the appended figures, among which:

FIG. 1 is a perspective view of an electrical storage battery according to the disclosure, with part of the outer casing not shown to reveal the internal components of the battery;

FIG. 2 is a perspective view of a cell of the battery of FIG. 1, with some of the pouch being torn away to show the terminals;

FIG. 3 is a graphical representation from a numerical simulation of the battery in FIG. 1, showing the equivalent thermal resistance of a cell as a function of pouch height and terminal length;

FIG. 4 is a schematic representation of the results of a simulation, showing the temperature of the pouch cell in FIG. 3 under normal use;

FIG. 5 is a perspective view of the chassis of the battery of FIG. 1;

FIG. 6 is a schematic top view of two modules arranged in one of the housings of the battery of FIG. 1; and

FIG. 7 is a schematic representation of a technical solution for the cooling of pouch cells dissimilar to the designs shown in the rest of the disclosure.

### DETAILED DESCRIPTION

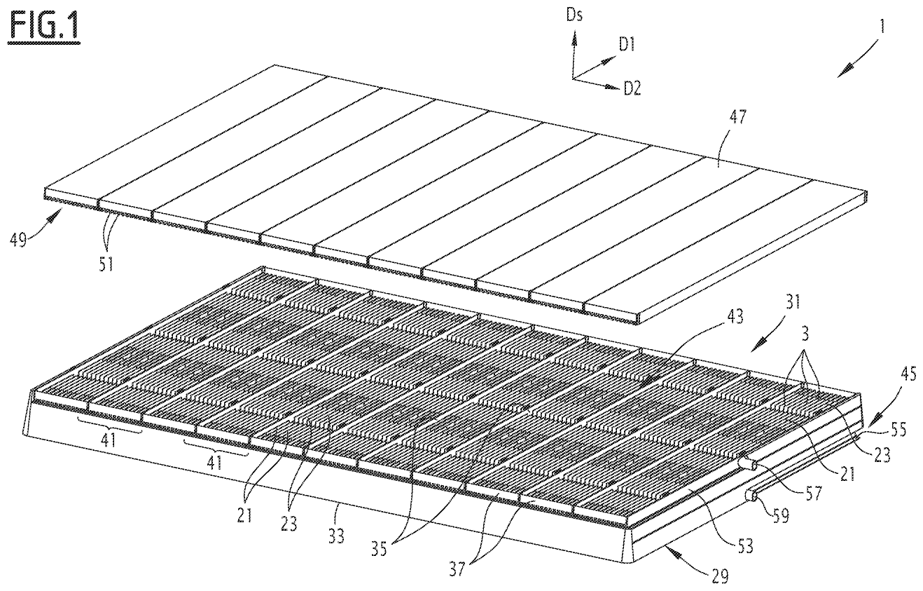

The electric battery 1 shown in FIG. 1 is intended for use in a vehicle, typically a motor vehicle such as a car, bus or truck.

The vehicle is, for example, a vehicle powered by an electric motor, the motor being electrically powered by the electric battery. In one variant, the vehicle is of the hybrid type, and thus comprises an internal combustion engine and an electric motor powered electrically by the electric battery. In yet another variant, the vehicle is powered by an internal combustion engine, with the electric battery being provided to power other vehicle equipment, for example the starter, lights, etc.

The electricity storage battery 1 comprises a plurality of pouch cells 3.

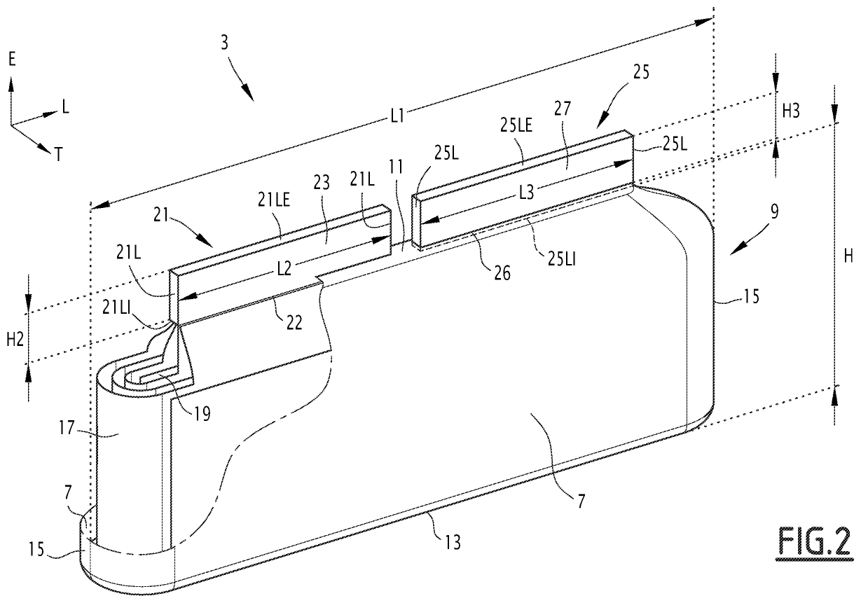

A pouch cell 3 is illustrated in FIG. 2.

The pouch cells are named «pouch» in English.

Each pouch cell 3 comprises a sealed pouch 5 made of a flexible material.

The pouch 5 has two large faces 7 opposite each other and a side 9 connecting the two large faces 7 to each other.

The side 9 comprises a longitudinal large upper edge 11 and a longitudinal large lower edge 13 opposite each other.

The side 9 further comprises two small edges 15 opposite each other, each connecting the large upper edge 11 and the large lower edge 13 to each other.

The pouch 5 is typically made of a soft plastic material.

The side 9 is typically generally rectangular in shape, in the sense that the small edges 15 extend along a elevation direction E substantially perpendicular to the longitudinal direction L. The large edges 11, 13 extend along general directions parallel to each other. The small edges 15 are parallel to each other.

The longitudinal large edges 11, 13 are longer than the small edges 15.

The pouch 5 thus has a generally elongated shape along the longitudinal direction L.

The pouch 5 has a small thickness compared to its other dimensions. The thickness is taken here along a transverse direction T, perpendicular to the elevation direction E and the longitudinal direction L, and corresponds to the distance between the two large faces 7.

Typically, the thickness of the pouch 5 is a few millimetres.

In the example shown, the small edges 15 each have a half-cylinder shape. Alternatively, they are flat or have any other shape.

In the example shown, the large upper edge 11 has a longitudinal flat top ridge, and sloping areas connecting the top ridge to the large faces 7 and small edges 15. Alternatively, the large upper edge 11 is entirely flat, or has any other shape.

In the example shown, the large lower edge 13 is flat.

The pouch cell 3 also has an cathode 17 and a anode 19, arranged inside the pouch 5.

In the example shown in FIG. 2, the cathode 17 and anode 19 are nested windings.

Alternatively, they may have any other suitable shape.

In addition, an electrolyte not shown fills the pouch 5. The pouch 5 is sealed against this electrolyte.

The electrolyte may be in liquid or gel form, or in any other form.

The pouch cell 3 is for example of the Li-ion type, the electrolyte comprising Li ions. The pouch cell 3, as an alternative, is of any other type.

The pouch cell 3 further comprises a positive terminal 21, which emerges from the pouch 5 through the large upper edge 11.

The positive terminal 21 comprises an inner positive part 22 located inside the pouch 5 and electrically connected to the cathode 17.

The positive terminal 21 also has an outer positive part 23 located outside the pouch 5.

The inner positive part 22 is electrically connected to the cathode 17 by any suitable means, for example by welding.

The pouch cell 3 further comprises a negative terminal 25, which emerges from the pouch 5 through the large upper edge 11.

The negative terminal 25 comprises an inner negative part 26 located inside the pouch 5 and electrically connected to the anode 19. It also has an outer negative part 27 located outside the pouch 5.

The positive terminal 21 and the negative terminal 25 are metal plates.

The inner and outer positive parts 22, 23 are thus areas of the plate constituting the positive terminal 21.

Similarly, the inner and outer negative parts 26, 27 are areas of the plate constituting the negative terminal 25.

These plates are typically made of copper for the positive terminal 21 and aluminium for the negative terminal 25.

Advantageously, the positive and negative terminals 21, 25 extend in the same plane containing the longitudinal direction L and the elevation direction E.

In the example shown, the positive and negative terminals 21, 25 emerge from the pouch 5 through the top ridge of the large upper edge 11.

According to the present disclosure, the pouch cells 3 are cooled entirely through the positive terminal 21 and the negative terminal 25. In other words, almost all the heat generated by the pouch cell 3 during the operation of the battery 1 is dissipated via the positive terminal 21 and the negative terminal 25.

As described below, almost all of the heat generated is removed by circulating a dielectric fluid directly in contact with the positive terminal 21 and the negative terminal 25.

Typically, at least 90% of the heat generated by the pouch cell 3 is removed via the positive terminal 21 and the negative terminal 25, preferably at least 95% of the heat.

To do this, the positive terminal 21 and the negative terminal 25 are sized to carry both the electricity generated by the pouch cell 3 and the heat. The geometry of the terminals 21 and 25 is therefore adapted for both flows, the design-basis flow being the thermal flow.

The removal of heat generated by the pouch cell 3 is a function of the quality of the heat transfer between the interior of the pouch cell 3 and the positive and negative terminals 21, 25, and also a function of the quality of the heat transfer between the outer positive part 23 or the outer negative part 27 and the dielectric fluid flowing in contact with the terminals 21, 25.

The applicant has determined that the best approach to increase the heat flow between the interior of the pouch cell 3 and the terminals 21, 25 is to increase the longitudinal length of the terminals 21, 25.

This is because the positive and negative terminals 21, 25 cannot plunge deep into the interior of the pouch 5, without interfering with the internal members of the pouch 5. The interior of the pouch 5 is in fact mainly occupied by the windings of the cathode 17 and the anode 19, interleaved with each other to maximise the energy density.

The applicant has also determined that the thickness of the terminals 21, 25 must remain within certain limits so as not to degrade the thermal homogeneity of the pouch cell 3 in operation or the heat transfers between the terminals 21, 25 and the dielectric heat transfer fluid.

Thus, the appropriate parameter to increase the heat flow between the interior of the pouch cell 3 and the terminals 21, 25 is mainly the longitudinal length of these terminals 21, 25.

The large upper edge 11 of the side has a longitudinal edge length L1.

The edge length L1 corresponds to the total length of the large upper edge 11, taken in the longitudinal direction L, including the top ridge and the sloping areas. The edge length L1 also corresponds to the total form factor of the pouch cell 3 in the longitudinal direction L.

The positive terminal 21 has a longitudinal length L2 and the negative terminal 25 has a longitudinal length L3.

Advantageously, the positive terminal 21 and the negative terminal 25 together have a total longitudinal terminal length of more than 70% of the edge length L1. The ratio (L2+L3)/L1 is thus preferably: greater than or equal to 70%, greater than or equal to 75%, greater than or equal to 80%, greater than or equal to 85, greater than or equal to 90%, greater than or equal to 95%.

Typically, the positive terminal 21 is a rectangular plate, lying in the plane containing the longitudinal direction L and the elevation direction E, mentioned above.

It is delimited by an external longitudinal edge 21LE, an internal longitudinal edge 21LI, and two lateral edges 21L. The outer longitudinal edge 21LE and the inner longitudinal edge 21LI are straight and extend in the longitudinal direction L. The side edges 21L are straight and extend in the elevation direction E.

The longitudinal length L2 of the positive terminal 21 corresponds to the longitudinal distance between the side edges 21L.

Likewise, the negative terminal 25 is typically a rectangular plate, also lying in the plane containing the longitudinal direction L and the elevation direction E, mentioned above.

It is delimited by an external longitudinal edge 25LE, an internal longitudinal edge 25LI, and two lateral edges 25L. The outer longitudinal edge 25LE and the inner longitudinal edge 25LI are straight and extend in the longitudinal direction L. The side edges 25L are straight and extend in the elevation direction E.

The longitudinal length L3 of the negative terminal 25 corresponds to the longitudinal distance between the side edges 25L.

To facilitate heat transfer between the terminals 21, 25 and the dielectric fluid, it is also important that the outer positive part 23 and/or the outer negative part 27 have a high surface area.

The heat flow between the terminals 21, 25 and the dielectric fluid is, in part, determined by the area of the terminals 21, 25 in contact with the dielectric fluid.

However, the surface area of the outer negative part 27 and the positive external part 23 cannot be excessively large, as this would reduce the size of the pouch cell 3.

Thus, the outer positive part 23 is formed of the entire part of the positive terminal 21 protruding from the pouch 5.

The outer positive part 23 has an area S2. In the example shown, this area S2 is equal to L2×H2, H2 being the height of the positive outer part 23 taken in the elevation direction E from the upper edge 11.

Similarly, the outer negative part 27 consists of the entire portion of the negative terminal projecting out from the pouch 5.

The outer negative part 27 has an area S3. This area is equal to L3×H3. The height H3 corresponds to the height of the outer negative part 27 taken in the elevation direction E from the upper edge 11.

The outer negative 27 and outer positive 23 parts together have a terminal area S equal to S2+S3.

Furthermore, the pouch 5 has a cross-section with a pouch area S′ in the same plane.

The applicant has determined that it is advantageous for the pouch area S′ to be between 7 and 11 times the terminal area S, more preferably between 8 and 10 times, and ideally 9 times the terminal area S.

The applicant further observed that it was preferable to keep the ratio between the height of the pouch 5 and the height of the outer negative part 27 within a predetermined range. Similarly, the ratio between the height of the pouch 5 and the height of the outer positive part 23 must be maintained in a given ratio, typically the same ratio as between the height of the pouch 5 and the height of the outer negative part 27.

As can be seen in FIG. 2, the pouch 5 has a pouch height H in the elevation direction E.

Advantageously, the ratio H/H3 is between 2 and 5, even more preferably between 3 and 4, and ideally 3.5.

Similarly, the ratio H/H2 is preferably between 2 and 5, more preferably 3 and 4 and ideally 3.5.

If the height of the pouch 5 is too high, some areas inside the pouch 5 will be poorly cooled. These areas are typically those furthest from the terminals 21, 25. The height of the pouch 5 is therefore limited either by a maximum temperature to be reached in the area of the pouch opposite the terminals, or by a temperature gradient within the pouch 5 between the hottest and the least hot areas. This gradient is for example between 5 and 10 degrees. If these criteria are not met, heterogeneous ageing of the pouch 3 cell can occur, with the hottest part ageing prematurely.

The pouch height H is thus preferably less than 80 mm, more preferably less than 70 mm.

The heights H2 and H3 of the terminals must be sufficient to ensure that the surface area of the terminals in contact with the dielectric fluid is large and to allow convective exchanges ensuring good cooling. The heights H2 and H3 of the terminals should not be too great, however, so that the total height of the pouch cell is kept within an expected range, taking into account the height of the pouch.

Indeed, the height of the battery is strictly limited for reasons of space on board the vehicle.

Choosing a terminal height that is too high could also lead to an excessive reduction in the height of the pouch and ultimately reduce the amount of energy stored in the battery.

Thus, the applicant believes that the ratio chosen makes it possible to reconcile thermal homogeneity in the pouches, the cooling of the cells by convective exchanges between the terminals and the dielectric liquid, the height of the pouch cells, and the quantity of energy stored in each pouch cell.

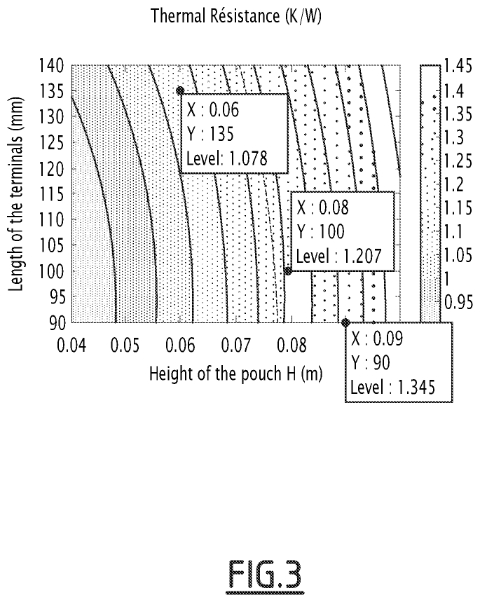

FIG. 3 is a map showing the thermal resistance that can be obtained for a typical pouch cell, in accordance with the present disclosure, as a function of the height H of the pouch 5 (on the x-axis, expressed in metres), and as a function of the length of the terminals.

The length is on the y-axis, expressed in millimetres. It corresponds to the length of one of the terminals 21, 25, it being understood that the length of the positive terminal is considered here equal to the length of the negative terminal.

The thermal resistance Rₜₕ is expressed in ° K per Watt. It characterises the thermal resistance of the cell to heat transfer from the dielectric fluid to the cell interior. The thermal resistance Rₜₕ is expressed as follows:

$${T}_{c e l l} = \dot{{Q}_{total}} \times {R}_{th} + {T}_{c o o l}$$

$${R}_{t h} = \sum {R}_{t h , i} = {R}_{t {h}_{cell}} + {R}_{t {h}_{tab}} + {R}_{t {h}_{fluid}}$$

where:

T_{cell} is the average temperature of the pouch cell 3;
T_{cool} is the average temperature of the dielectric fluid in contact with the terminals 21, 25;
Qºₜₒₜₐₗ is the heat flow from the pouch cell 3 to the dielectric fluid;
R_{th cell} is the thermal resistance for heat transfer between the internal elements of the pouch cell 3 and the terminals 21, 25;
R_{th tab} is the thermal resistance for conductive heat transfer along the terminals 21, 25;
R_{th fluid} is the thermal resistance for heat transfer between the terminals 21, 25 and the dielectric fluid.

Comparing thermal resistances allows different ways of cooling cells in a stationary state of charge to be compared, regardless of transient conditions related to cell mass or specific heat.

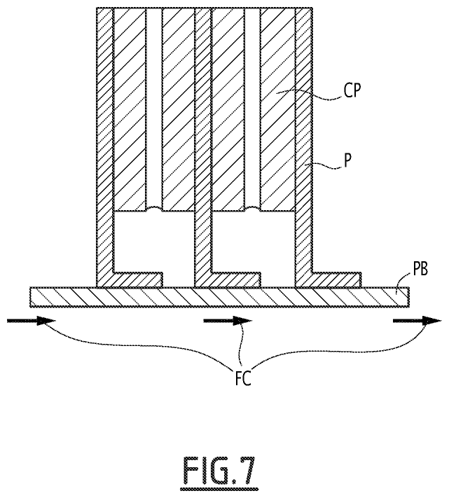

For a pouch cell device in which heat is removed via aluminium plates sandwiched between the large faces of the pouch cells, of the type shown in FIG. 7, the thermal resistance is approximately 1.18 K/W. This value corresponds to the dashed line in FIG. 3.

For a pouch cell of the type described above, with a pouch height of 60 millimetres and positive and negative terminals of length 135 millimetres, the thermal resistance is approximately 1.08 K/W.

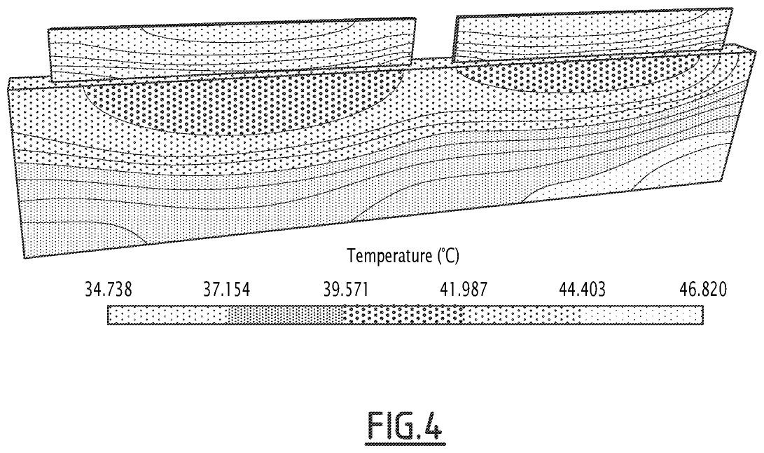

FIG. 4 shows the temperature distribution for such a pouch cell 3 in a typical operating situation. The maximum temperature is observed in the lower right-hand corner, and is about 47° C. This value compares favourably with the temperature distributions obtained in the state of the art, especially in the cells of FIG. 7.

The cell in FIG. 7 has terminals coming out of the short sides of the pouch. The pouch typically has the following dimensions: longitudinal length 291 mm, height in the elevation direction 91 mm, thickness 12.7 mm. This cell has an electricity storage capacity of 62 Ah. As mentioned above, for cooling using aluminium plates sandwiched between the large pouch cell faces, with the intermediate aluminium plates transferring heat to a cooled bottom plate, the equivalent thermal resistance is 1.18 K/W.

The pouch cell 3 of the present disclosure, designed to be cooled solely by the positive terminal 21 and negative terminal 25, by direct contact with a dielectric fluid, has the following dimensions: longitudinal length 370 mm, height excluding terminals 70 mm, thickness 12.7 mm. The electricity storage capacity is also 62 Ah. The equivalent resistance is 1.07 K/W.

The two cells have a similar overall form factor. The length of the cell in FIG. 7, taking into account the terminals, is 367 mm, very close to the pouch cell 3 of the present disclosure. The height of the pouch cell 3 of the present disclosure, taking into account the terminals, is 90 mm.

The pouch cell 3 of the present disclosure therefore has a slightly lower equivalent thermal resistance than the cell in FIG. 7, for a comparable size. In contrast, the integration of the pouch cell 3 of the present disclosure into an electricity storage battery is much simpler, as described below.

The electricity storage battery 1 comprises an outer casing 29, internally bounding a volume 31 for receiving the pouch cells 3. The outer casing 29 typically has a base 33 and a lid not shown.

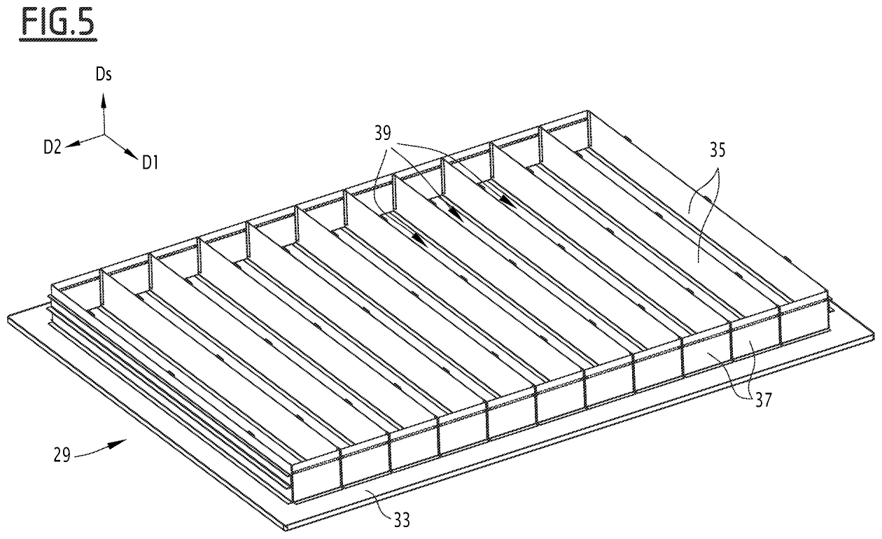

In the example shown in FIG. 5, the base 33 is a substantially flat plate, constituting a frame supporting the weight of the pouch cells 3.

For example, the lid is concave towards the base 33. It has a substantially flat upper base, a peripheral edge surrounding the upper base and a projecting flange. The flange extends the peripheral edge outwards from the lid and is pressed against the base 33.

In the example shown, the base 33 of the outer casing 29 is rectangular.

As can be seen in FIG. 5, the electricity storage battery 1 further comprises beams 35, 37 rigidly attached to the outer casing 29 and, delimiting in the receiving volume 31, a plurality of housings 39.

The beams 35, 37 are metal plates. They are rigidly fixed to the base 33. Each housing 39 is delimited by two beams 35 extending along a first direction D1, and two beams 37 extending along a second direction D2, perpendicular to the first direction D1.

In the example shown, the battery 1 comprises a single row of housings 39. The housings 39 are elongated along the first direction D1. They are juxtaposed along the second direction D2.

The pouch cells 3 are distributed in several modules 41, each module 41 being inserted in one of the housings 39.

A module 41 is a set of pouch cells 3 with the large faces 7 pressed together.

The modules 41 are arranged in the housings 39 in such a way that the longitudinal direction L corresponds to the first direction D1 and the transverse direction T to the second direction D2.

In a single module 41, the pouch cells 3 are therefore juxtaposed transversely, i.e. along the second direction D2.

Within the same housing 39, the modules 41 are juxtaposed longitudinally, i.e. along the first direction D1. In the example shown, a housing 39 holds four modules 41.

As seen in particular in FIG. 1, the pouch cells 3 are arranged so that the large top ridges 11 define a top surface 43.

This upper surface 43 is substantially flat, with all pouch cells 3 having substantially the same height taken along the elevation direction E.

The large upper edges 11 all face in the same upper direction Ds, corresponding here to the elevation direction E. The large lower edges 13 rest on the base 33.

The positive terminals 21 and the negative terminals 25 project from the top surface 43 in the upper direction Ds.

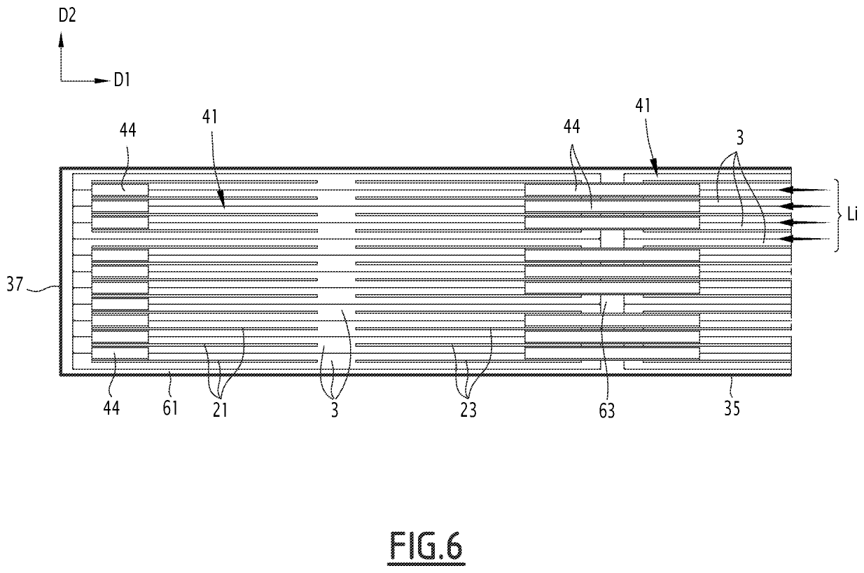

The pouch cells 3 are arranged so that the positive and negative terminals 21, 25 lie in a plurality of longitudinal straight lines Li parallel to each other (FIG. 6).

In the example shown, the pouch cells 3 of the modules 41 arranged in the same housing 39 are aligned longitudinally. In other words, each Li line comprises the positive and negative terminals 21, 25 of one of the pouch cells 3 of each of the modules 41 in the housing 39.

The positive and negative terminals 21, 25 of the pouch cells 3 are electrically connected to each other by connectors 44, the pouch cells 3 thus being placed in series and/or in parallel with each other. These connectors 44, also known as bus bars, are only partially shown in the figures.

The battery 1 further comprises a circuit 45 for cooling the pouch cells 3, containing a dielectric fluid.

The dielectric fluid is for example a liquid, typically an oil.

The cooling circuit 45 is configured so that the dielectric fluid flows in direct contact with the positive and negative terminals 21, 25 of the pouch cells 3.

More specifically, it is configured so that the pouch cells 3 are cooled only by circulation of the dielectric fluid in direct contact with the positive and negative terminals 21, 25 of the pouch cells 3.

For this purpose, the battery 1 comprises a plate 47 with a lower surface 49 facing the upper surface 43 (FIG. 1). The plate 47 substantially covers the entire top surface 43. In other words, it covers substantially all the housings 39 in which the pouch cells 3 are inserted.

A plurality of dielectric fluid circulation channels 51 are provided in the lower surface 49.

The positive and negative terminals 21, 25 of the pouch cells 3 are engaged in the channels 51.

The channels 51 are open along their entire length towards the upper surface 43, to allow the terminals 21, 25 to be received.

The channels 51 are straight, and extend over substantially the entire width of the battery 1, along the first direction D1.

They extend substantially along the entire length of the housings 39 in the direction D1, from one beam 37 to the other beam 37.

The positive and negative terminals 21, 25, lying in the same straight line Li, are engaged in the same channel 51.

For example, the plate 47 has a channel 51 for each line Li.

Alternatively, each channel 51 receives the terminals 21, 25 located in two or more adjacent lines Li.

Advantageously, the electrical connectors 44 are also received in the channels 51, so as to improve heat transfer between the pouch cells 3 and the dielectric fluid.

The cooling circuit 45 comprises a distribution manifold 53, which distributes the dielectric fluid to the channels 51. It further comprises a drain manifold 55, collecting the dielectric fluid leaving the channels 51.

Typically, the outer casing 29 has a heat transfer fluid inlet 57, through which the dielectric fluid enters the cooling circuit 45 (FIG. 1). It also has a dielectric fluid outlet 59, through which the dielectric fluid exits the cooling circuit 45.

The dielectric fluid inlet 57 and outlet 59 are intended to be connected to an on-board cooling system in the vehicle, typically comprising a dielectric fluid circulator and a heat exchanger. The heat exchanger is designed to remove the heat generated by the pouch cells 3. The circulator sets the dielectric fluid in motion. Its discharge is fluidly connected to the dielectric fluid inlet 57 and its suction is fluidly connected to the dielectric fluid outlet 59.

Alternatively, the heat exchanger and the circulator are integrated into the electricity storage battery. If they are, the drain manifold is fluidly connected to an inlet of the heat exchanger, the distribution manifold being fluidly connected to the outlet of the circulator.

The suction side of the circulator is connected to the outlet of the heat exchanger.

As can be seen in FIG. 6, each module 41 is rigidly attached to the beams 35, 37 of the housing 39 which receives it by a layer 61 of elastic resin.

The modules 41, inserted in one housing 39, are separated from each other by a layer 63 of said elastic resin.

Typically, the housings 39 are slightly wider in the second direction D2 than the modules 41. Similarly, the length of each housing 39, along the first direction D1, is slightly greater than the length of the modules 41, placed in said housing 39.

The modules 41 are thus placed in the housing 39 in such a way that there is a gap between the modules 41 and the beams 35.

There is also a gap between the modules 41, placed at the ends of the housing 39, and the beams 37.

There are still gaps between the modules 41.

These gaps are filled with the resin 61, 63 once the modules 41 are in place in the housings 39.

The resin is poured into the gaps after the module 41 is in place, thus joining the modules 41 to each other and to the beams 35, 37.

The pouch cell 3 and the electricity storage battery 1 described above have multiple advantages.

The pouch cell is specifically designed to allow efficient cooling by a dielectric fluid flowing in contact with the positive and negative terminal, while allowing simple integration within the battery.

The choice of a ratio between 2 and 5, for the height of the pouch to the height of the outer negative part and/or the outer positive part, makes it possible to limit the temperature gradients within the pouch cell, while keeping a sufficient height for the terminals. This height is sufficient for proper cooling of the pouch cell. This ratio leads to a relatively small footprint in height of the battery. This is advantageous for housing the battery on board the vehicle.

The choice of the ratio between the surface area of the pouch and the surface area of the outer negative and outer positive parts leads to satisfactory heat transfers between the terminals and the dielectric fluid, without excessively increasing the size of each cell.

The fact that the pouch cells are cooled only by circulation of the dielectric fluid in direct contact with the terminals leads to a very simple battery structure. The fact that the positive and negative terminals are brought together on the same side of the pouch cell contributes to the same result.

The use of a plate placed opposite the large upper edges of the pouch cells to create the channels for the circulation of the heat transfer fluid makes it possible to carry out the circulation of the dielectric fluid in a simple manner. This circuitry is particularly easy when the positive and negative terminals are arranged in rows, and as such the channels can be straight.

The use of an elastic resin layer to lock the modules in the corresponding housings makes it easy to lock the pouch cells in these housings.

1. An electricity storage pouch cell, the pouch cell comprising:
a sealed pouch made of a flexible material, having two large faces opposite each other and a side connecting the two large faces to each other, the side comprising a longitudinal large upper edge and a longitudinal large lower edge opposite each other, the side further comprising two small edges opposite each other and connecting the large upper edge and the large lower edge to each other;
a cathode and an anode, arranged inside the pouch;
a positive terminal emerging from the pouch through the large upper edge, the positive terminal having an inner positive part located inside the pouch and electrically connected to the cathode, and an outer positive part located outside the pouch;
a negative terminal emerging from the pouch through the large upper edge, the negative terminal having an inner negative part located inside the pouch and electrically connected to the anode, and an outer negative part located outside the pouch;
the large upper edge of the side having a longitudinal edge length;
the positive terminal and the negative terminal together having, longitudinally, a terminal length greater than 70%, and preferably greater than or equal to 80% of the edge length.

2. The pouch cell according to claim 1, wherein the positive and negative terminals are plates extending in a single plane containing the longitudinal direction and an elevation direction, substantially perpendicular to the longitudinal direction.

3. The pouch cell according to claim 2, wherein the pouch has a pouch height in the elevation direction; and
wherein the outer negative part has at least one of (1) along the elevation direction, a negative terminal height such that the pouch height is between 2 and 5 times the height of the outer negative part of the negative terminal, and (2) along the elevation direction, a positive terminal height such that the pouch height is between 2 and 5 times the height of the outer positive part of the positive terminal.

4. The pouch cell according to claim 2, wherein the positive and negative terminals together have, in said plane, a terminal area, the pouch having, in said plane, a cross-section with a pouch area between 7 and 11 times the terminal area.

5. An electricity storage battery comprising:
a plurality of electricity storage pouch cells, each pouch cell comprising:
a sealed pouch made of a flexible material, having two large faces opposite each other and a side connecting the two large faces to each other, the side comprising a longitudinal large upper edge and a longitudinal large lower edge opposite each other, the side further comprising two small edges opposite each other and connecting the large upper edge and the large lower edge to each other;
a cathode and an anode, arranged inside the pouch;
a positive terminal emerging from the pouch through the large upper edge, the positive terminal having an inner positive part located inside the pouch and electrically connected to the cathode, and an outer positive part located outside the pouch;
a negative terminal emerging from the pouch through the large upper edge, the negative terminal having an inner negative part located inside the pouch and electrically connected to the anode, and an outer negative part located outside the pouch;
an external casing, internally delimiting a volume for receiving the pouch cells, the pouch cells being arranged in such a way that the large upper edges are turned in the same upper direction;
a circuit for cooling the pouch cells containing a dielectric fluid, the cooling circuit being configured so that the dielectric fluid flows in direct contact with the positive and negative terminals of the pouch cells.

6. The electricity storage battery according to claim 5, wherein the pouch cells are cooled only by circulation of the dielectric fluid in direct contact with the positive and negative terminals of the pouch cells.

7. The electricity storage battery according to claim 5, wherein the large upper edge of the side having a longitudinal edge length;
the positive terminal and the negative terminal together having, longitudinally, a terminal length greater than 70%, and preferably greater than or equal to 80% of the edge length.

8. The electricity storage battery according to claim 5, wherein the large upper edges of the pouch cells define a top surface, the battery comprising a plate having a lower surface facing the top surface, the lower surface having a plurality of dielectric fluid channels formed therein, the positive and negative terminals of the pouch cells being engaged in the channels.

9. The electricity storage battery according to claim 8, wherein the channels are straight and extend across substantially the entire width of the battery, the pouch cells being arranged such that the positive and negative terminals lie in a plurality of straight lines parallel to each other, the positive and negative terminals lying in the same straight line being engaged in the same channel.

10. The electricity storage battery according to claim 5, wherein the battery comprises beams rigidly fixed to the casing and, delimiting in the receiving volume, a plurality of housings, the pouch cells being distributed in a number of modules, each module being inserted into one of the housings and rigidly attached to the beams by a layer of elastic resin.

11. The electricity storage battery according to claim 10, wherein a plurality of modules are inserted in a single housing, said modules being separated by a layer of said elastic resin.
